(19) United States
(12) Patent Application Publication
(10) Pub. No.: US 2022/0309506 A1
(43) Pub. Date: Sep. 29, 2022

(54) SYSTEM AND METHOD VERIFYING CARD HOLDER WITH ONE TIME PASSWORD IN SOFTWARE BASED POS'S

(71) Applicant: Kartek Kart Ve Bilisim Teknolojileri Ticaret Anonim Sirketi, Istanbul (TR)

(72) Inventors: Hasan YASSIBAS, Istanbul (TR); Ahmet AKGÜN, Istanbul (TR)

(21) Appl. No.: 17/610,780

(22) PCT Filed: Nov. 13, 2020
(86) PCT No.: PCT/TR2020/051105

§ 371 Date: Nov. 12, 2021

(30) Foreign Application Priority Data
Mar. 2, 2020 (TR) 2020/03177

(51) Int. Cl. G06Q 20/40; G06Q 20/38; G06Q 20/42; G06Q 20/32; G06Q 20/34

(52) U.S. Cl. CPC G06Q 20/405; G06Q 20/385; G06Q 20/425; G06Q 20/3255; G06Q 20/3223; G06Q 20/352; G06Q 20/353; G06Q 20/341

(57) ABSTRACT

A system and a method providing OTP (one time password) to verify a card holder in transactions over CVM (Cardholder Verification Method) limit for devices receiving EMV contactless payment commercially available on shelf by a software based SoftPOS mobile application.

### TECHNICAL FIELD

Invention relates to a system and method providing OTP (One Time Password) verify card holder in transactions over CVM (Cardholder Verification Method) limit for devices accepting EMV contactless payment commercial off the shelf by software based SoftPOS mobile application.

### PRIOR ART

There are three fundamental limit concepts in contactless transactions made by physical POS devices in payment world: Contactless limit, CVM limit and floor limit. Contactless limit means maximum limit allowed for contactless payment, CVM limit corresponds to minimum limit requiring cardholder's verification, floor limit means the maximum limit that can be approved offline for a transaction. Therefore, a transaction is determined whether online or offline, if online, whether CVM verification or without verification are all subject to limits. If contactless transaction is of an amount less than contactless transaction limit and is equal to or bigger than CVM limit, CVM verifications are conducted and transaction is performed online. If CVM controlled, cardholder is requested to provide Online PIN or do it with signature method. However, for amounts above CVM limits for commercial mobile devices available on shelf, PIN entrance has not been provided by organizations regulating payment world yet. For security reasons, card reading section and PIN entering section should be separate. In current POS devices these two sections are in the same box and insulated hardware and have are certified by certificate tests. Since mobile devices commercially available on shelf do not have such separate sections in terms of hardware, some solutions in terms of software are sought.

In conclusion, it has been necessary to invent a novelty in the related art for the above mentioned issues not having been solved in the light of the related art.

### BRIEF DESCRIPTION OF THE INVENTION

In order eliminate above disadvantages and bring new advantages in the prior art, present invention relates to a system and method verifying card holder with one time password in software based SoftPOS.

Primary purpose of invention is to develop a system and method providing one time password as method of verification of card holder alternate for online PIN use in case of CVM limit excess.

Another purpose of the invention is to create a system and method providing transaction based dynamic password management.

A further purpose of the invention is to disclose a system and method providing submission of dynamic password through card holder's bank and providing incorporation of password into authorization streaming by adding new fields in interbank messaging.

In order to achieve all purposes mentioned above and to be understood better with the details given below, the invention is a system providing one time password used to verify card holder in transactions in amounts above limits by mobile devices charging by SoftPOS software. Accordingly; the system comprises;
A payment instrument having contactless transaction feature,
A SoftPOS application running on a mobile device, providing taking payment by approaching said payment instrument to mobile device, comprising OTP interface allowing entrance of said payment instrument holder's (cardholder's) one time password and/or displaying message requesting submission of authorization for verification of cardholder,
A SoftPOS server recognizing said SoftPOS application and mobile device whereon SoftPOS application runs and executing security controls,
Identity verification server conducting issuer bank distinction on basis of payment unit details for submission of one time password,
User' mobile device owned by user and where one time password and/or PUSH notification is sent,
An SMS network gateway owned by issuer bank and sending one time password to user's device for getting user authorization for cardholder verification, Application server owned by issuer bank and providing sending of PUSH notice for verification authorization for payment unit holder verification,

Our invention also discloses a method providing one time password used to verify card holder in transactions in amounts above limits by mobile devices charging by SoftPOS software. Accordingly, the method comprises the process steps of;
Entrance of payment amount by running SoftPOS application providing receipt of payment,
Tapping of payment instrument to SoftPOS application,
Execution of EMV transaction flow by SoftPOS application,
Transmission of cardholder verification request to SoftPOS server executing security controls,
Sending cardholder verification request to an identity verification server by SoftPOS server,
Determining of issuer bank and sending cardholder verification request to issuer bank by identity verification server,
Forwarding of cardholder verification request to user device by an SMS network gateway sending one time password and/or an application server capable to send PUSH notification, and receiving required authorization,
Identifying values of OTP and BTN (Bank Transaction Number) values coding authorization request message displayed in ISO subfields under acquiring key and writing code symbolizing SoftPOS application processes into “POS Entry Mode” and transmitting to SoftPOS application holder bank (acquirer) by SoftPOS server,
Transmission of request message delivered to acquirer bank to issuer bank,
Parsing ISO fields and controlling OTP and BTN values by issuer bank,
In case authorization request fails, displaying of information indicating that transaction is declined in SoftPOS application,
In case authorization request is correct, displaying of information indicating that transaction is approved in SoftPOS application.

In order to make the embodiment and additional members being subject of the present invention as well as the advantages clearer for better understanding, it should be assessed with reference to the following described figures.

### BRIEF DESCRIPTION OF FIGURES

FIG. 1 is a schematic view of the system disclosed under the invention.

FIG. 2 is flow chart diagram of the method disclosed under the invention.

### REFERENCE NUMBERS

1. Payment instrument
2. SoftPOS application
2.1. L3 work layer
2.2. L2 Kernel
2.3. OTP interface
3. SoftPOS server
3.1. HSM unit
4. Identity verification server
5. Acquirer Bank
6. Issuer Bank
6.1. SMS network gateway
6.2. Application server
7. User device
7.1. Mobile Banking application
1001. Entrance of payment amount by running SoftPOS application providing receipt of payment
1002. Tapping of payment instrument to SoftPOS application
1003. Execution of EMV transaction flow by SoftPOS application
1004. Transmission of cardholder verification request to SoftPOS executing security controls
1005. Sending cardholder verification request to identity verification server by SoftPOS server
1006. Determining of issuer bank and sending cardholder verification request to issuer bank by identity verification server
1007. Forwarding of cardholder verification request to user device by an SMS network gateway sending one time password and/or capable to send PUSH notification, and receiving required authorization
1007a. Transmission of cardholder verification request by issuer bank to SMS network gateway which will send one time password,
1007b. Sending PUSH notification to mobile banking application by application server
1008a. Sending one time password to cardholder's mobile device by SMS network gateway
1008b. Sending information showing that notice is sent to identity verification server by issuer bank's
1009a. Sending information of one time password sending states to identity verification server together with BTN number by issuer bank
1009b. Sending notice status information to SoftPOS server by identity verification server
1010a. Sending one time password status information to SoftPOS server by Identity verification server
1010b. Transmitting notice status information to SoftPOS application by SoftPOS server
1011a. Sending one time password status information to SoftPOS application by SoftPOS server
1011b. Displaying of approval request message in SoftPOS application
1012a. If one time password status information is correct, opening of OTP entry interface in SoftPOS application
1012b. Giving approval over mobile banking application running on mobile device by cardholder
1013a. Entrance of one time password over SoftPOS application by cardholder
1013b. Transmitting authorization request message to POS server by SoftPOS application
1014a. Sending authorization request message together with one time password to SoftPOS server by SoftPOS application
1015. Identifying values of OTP and BTN values coding authorization request message displayed in ISO fields under acquiring key and writing code symbolizing SoftPOS application processes into “POS Entry Mode” and transmitting to acquirer bank by SoftPOS server,
1016. Transmission of request message delivered acquirer bank to issuer bank,
1017. Parsing ISO fields and controlling OTP and BTN values by issuer bank
1018a. In case authorization request fails, displaying of information indicating that transaction is declined in SoftPOS application
1018b. In case authorization request is correct, displaying of information indicating that transaction is approved in SoftPOS application

### DETAILED DESCRIPTION OF THE INVENTION

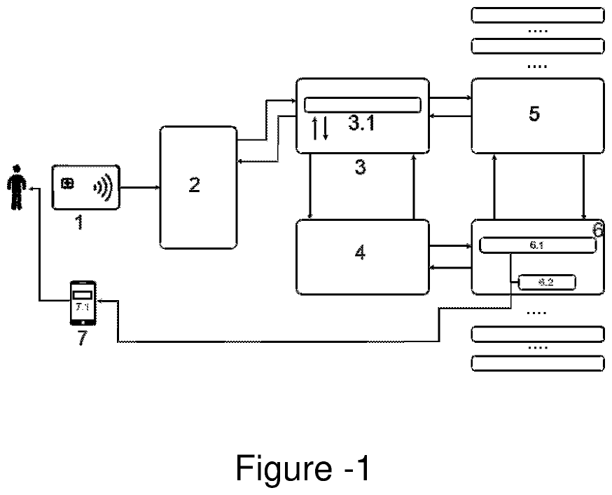

In this detailed description, novelty being subject of this invention has been disclosed solely for the purpose of better understanding of the subject and with samples described in a manner not causing any restrictive effect. Our invention is a system for use of one time password to verify card holder in transactions with excess limit by payment accepting mobile devices by means of SoftPOS software. A schematic view of the system disclosed under the invention is given in FIG. 1. Accordingly the system comprises a payment instrument (1) having contactless transaction feature; a SoftPOS application (2) comprising OTP interface (2.3) running on a mobile device, providing receipt of payment by approving said payment instrument (1) to mobile device, providing entrance of one time password by cardholder and/or displaying message requesting authorization for verification of cardholder; SoftPOS server (3) recognizing said SoftPOS application (2) and mobile device on which SoftPOS application runs, and performing security controls; identity verification server (4) distinguishing issuer bank (6) based on payment instrument (1) information for sending one time password; SMS network gateway (6.1) owned by user owned user device (7) issuer bank (6) where one time password is sent, and sending one time password to user device (7) for getting cardholder verification user approval; application server (6.2) owned by issuer bank (6) and providing sending of PUSH notice for getting cardholder verification user approval.

In a preferred application of the system, said SoftPOS application (2) comprises L3 work layer (2.1) managing user interface experience and workflows, L2 kernel (2.2) where core applications of payment charts are run.

Our invention also comprises mobile banking application (7.1) installed on user device (7) and where PUSH notification providing getting authorization from cardholder is sent.

Said SoftPOS server (3) comprises HSM unit (3.1) providing hardware functioning of security key and cryptographic algorithms.

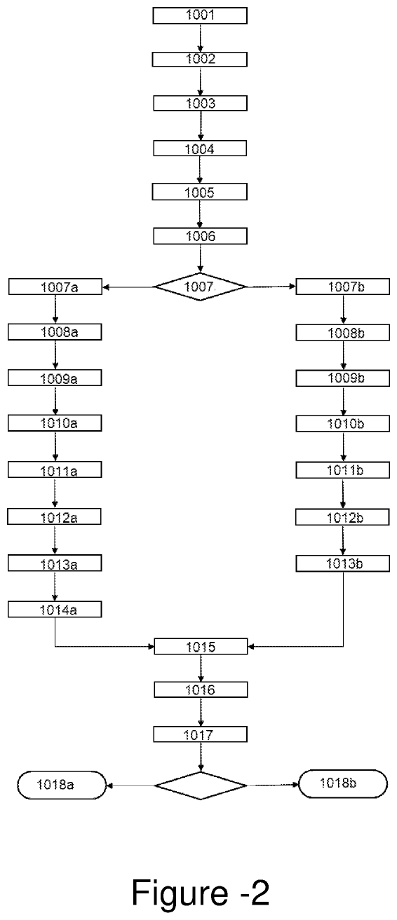

A flow diagram of the method disclosed under the invention is given in FIG. 2. Working principle of our invention is as follows:

Payment amount is entered by running SoftPOS application (2) providing receipt of payment. Card holder taps payment instrument (1) by SoftPOS application (2) after shopping. Communication between SoftPOS application (2) and payment instrument (1) is preferably provided by NFC. Said payment instrument (1) is characterized in being a card of contactless transaction feature or a mobile phone. SoftPOS application (2) is a mobile application developed as alternate of physical POS devices and running on preferably Android devices.

After payment instrument (1) is read by SoftPOS application (2) running on a mobile device, EMV payment flow is executed and cardholder verification request is sent to SoftPOS server (3) together with PAN information. SoftPOS server (3) transmits incoming request to identity verification server (4). Identity verification server (4) identifies issuer bank (6) and cardholder verification request is transmitted to issuer bank (6).

If user device (7) does not have mobile banking application (7.1):

Cardholder identification request is transmitted to SMS network gateway (6.1) which will send one time password (OPT) by issuer bank (6). SMS network gateway (6.1) sends one time password to cardholder's mobile device (7). Issuer bank (6) also submits OTM transmission information together with BTN (Bank Transaction Number) details to identity verification server (4). Identity verification server (4) sends OTP transmission details to SoftPOS server (3) and SoftPOS server (3) transmits it to SoftPOS application (2). After receipt of information by SoftPOS application (2), SoftPOS application (2) opens OTP interface (2.3) to enable card holder to enter OTP. cardholder makes OTP entrance. SoftPOS application (2) sends OTP information together with authorization data to SoftPOS server (3).

If user device (7) has mobile banking application:

Application server (6.2) sends PUSH notification to banking application (7.1). issuer bank (6) sends information showing that notice is sent, to identity verification server (4). Identity verification server (4) sends notice status information to SoftPOS server (3). SoftPOS server (3) transmits notice status information to SoftPOS application (2). SoftPOS application (2) gives a message to direct user to bank application. Cardholder gives approval by mobile banking application (7.1) running on mobile device (7). SoftPOS application (2) transmits authorization request message to SoftPOS server (3).

SoftPOS server (3) prepares authorization data according to ISO 8583 message structure. OTP data and BTN data are added into ISO message fields to be assigned. Code symbolizing SoftPOS application (2) operations are written to “POS Entry Mode” field to enable issuer bank (6) distinguish between SoftPOS operations. Authorization request message is transmitted to acquirer bank. Acquirer bank (5) sends request to issuer bank (6) for authorization confirmation. Issuer bank (6) parses ISO message. When POS Entry Mode is recognized as SoftPOS application (2), OTP and BTN values are checked and authorization confirmation or decline message is given.

If authorization request is successful,
Issuer bank (6) sends authorization message to acquirer bank (5).
Acquirer bank (5) sends message to SoftPOS server (3).
SoftPOS server (3) sends message of operation approval to SoftPOS application (2).
SoftPOS application (2) shows approval of transaction.

If authorization is not approved without any reasons;
Issuer bank (6) sends declined message to acquirer bank (5).
Acquirer bank (5) sends message to SoftPOS server (3).
SoftPOS server (3) sends message of operation denial to SoftPOS application (2).
   SoftPOS application (2) shows denial of transaction message.

1. A system providing use of a one time password to verify a card holder in transactions with excess limit by payment receiving mobile devices by use of SoftPOS software, characterized by comprising:
a payment instrument having contactless transaction feature,
a SoftPOS application running on a mobile device, providing taking payment by approaching said payment unit to mobile device, comprising an OTP interface allowing entrance of cardholder's one time password and/or displaying message requesting submission of authorization for verification of cardholder,
a SoftPOS server recognizing said SoftPOS application and mobile device whereon SoftPOS application runs and executing security controls,
an identity verification server conducting issuer bank distinction on basis of the payment instrument details for submission of the one time password,
a user device belonging to the user and to which the one time password is sent,
an SMS network gateway owned by the issuer bank and sending the one time password to the user's device for getting user authorization for cardholder verification,
an application server owned by the issuer bank and providing sending of a PUSH notification for verification authorization for cardholder verification.

2. The system according to claim 1, wherein the SoftPOS application comprises an L3 work layer managing user interface experience and workflows.

3. The system according to claim 1, comprising an L2 kernel where core applications based on payment schemes are executed.

4. The system according to claim 1, comprising a mobile banking application running on the user device and where to the PUSH notification providing getting user's authorization is sent.

5. The system according to claim 1, wherein the SoftPOS server comprises an HSM unit providing hardware functioning of security key and cryptographic algorithms.

6. The system according to claim 1, wherein said payment instrument is a card or a mobile phone with contactless transaction feature.

7. A method providing use of a one time password to verify a card holder in transactions with excess limit by payment receiving mobile devices by use of SoftPOS software, characterized by comprising process steps of:
entrance of payment amount by running a SoftPOS application providing receipt of payment (1001),
tapping of a payment instrument providing payment by the SoftPOS application (1002),
execution of EMV transaction flow by the SoftPOS application (1003),
transmission of a cardholder verification request to SoftPOS server executing security controls (1004),
SoftPOS server's sending cardholder verification request to an identity verification server (1005),
determining issuer bank and transmission of cardholder verification request to the issuer bank by identity verification server (1006),
forwarding of cardholder verification request to the user device by an SMS network gateway sending one time password and/or an application server capable to send PUSH notice, and receiving required authorization (1007),
identifying values of OTP and BTN values coding authorization request message displayed in ISO fields under acquiring key and writing code symbolizing SoftPOS application processes into “POS Entry Mode” and transmitting to acquirer bank by SoftPOS server (1015),
transmission of request message delivered to the acquirer bank to the issuer bank (1016),
parsing ISO fields and controlling OTP and BTN values by issuer bank (1017),
in case authorization request fails, displaying of information indicating that transaction is declined in SoftPOS application (1018a),
in case authorization request is correct, displaying of information indicating that transaction is approved in SoftPOS application (1018b).

8. The method according to claim 7, wherein if said user device has a mobile banking application, the method comprises process steps of:
sending a PUSH notification to the mobile banking application by the application server (1007b),
sending information showing that notice is sent to the identity verification server by the issuer bank (1008b),
sending notice status information to the SoftPOS server by the identity verification server (1009b),
transmission of notice status information to the SoftPOS application by the SoftPOS server (1010b),
displaying of approval request message in the SoftPOS application (1011b),
giving approval by the mobile banking application running on the mobile device by cardholder (1012b),
transmission of authorization request message to the SoftPOS server by the SoftPOS application (1013b).

9. The method according to claim 8, comprising the process step of displaying of a message approval request able to direct cardholder to the mobile banking application in the SoftPOS application.

10. The method according to claim 7, wherein if said user device does not have a mobile banking application, the method comprises process steps of:
transmission of cardholder identification request to an SMS network gateway which will send one time password by the issuer bank (1007a),
sending one time password to cardholder's mobile device by the SMS network gateway (1008a),
sending information of one time password sending status to the identity verification server together with BTN number by Payment unit holder bank (1009a),
sending no time password status information to the SoftPOS server by identity verification server (1010a),
sending one time password status information to the SoftPOS application by SoftPOS server (1011a),
if one time password status information is correct, opening of an OTP entry interface in the SoftPOS application (1012a),
entrance of one time password over the SoftPOS application by the cardholder (1013a),
sending authorization request message together with one time password to the SoftPOS server by the SoftPOS application (1014a).

11. The method according to claim 7, comprising the process step of submission of payment instrument verification request to the SoftPOS server together with coded PAN information.

12. The method according to claim 7, comprising the process step of management of user interface experience and workflows of SoftPOS application by an L3 wok layer.

13. The method according to claim 7, comprising the process step of running core applications of payment schemes by an L2 kernel.

14. The method according to claim 7, wherein if authorization request is correct, the method comprises process steps of:
issuer bank's sending an approval message to the acquirer bank,
acquirer bank's sending message to the SoftPOS server,
SoftPOS server's sending message of “operation approved” to the SoftPOS application (2),
display of approval of transaction on the SoftPOS application.

15. The method according to claim 7, wherein if authorization request is not correct, the method comprises process steps of:
issuer bank's sending a denial message to the acquirer bank,
acquirer bank's sending message to the SoftPOS server,
SoftPOS server's sending message of “operation denied” to the SoftPOS application,
display of denial of transaction on the SoftPOS application.

16. The method according to claim 7, comprising the process step of hardware operation of the SoftPOS server by means of a security key and cryptographic algorithms of HSM unit.

17. The method according to claim 7, comprising the process step of preparation of authorization data by the SoftPOS server according to ISO 8583 message structure.
